(19) United States
(12) Patent Application Publication
(10) Pub. No.: US 2016/0116741 A1
(43) Pub. Date: Apr. 28, 2016

(54) DISPLAY APPARATUS AND METHOD FOR CONTROLLING DISPLAY APPARATUS

(71) Applicant: SEIKO EPSON CORPORATION, Tokyo (JP)

(72) Inventor: Shinya SATO, Matsumoto-shi (JP)

(21) Appl. No.: 14/882,966

(22) Filed: Oct. 14, 2015

(30) Foreign Application Priority Data
Oct. 27, 2014 (JP) 2014-218236

(51) Int. Cl. G02B 27/01; G06T 19/00; G06F 3/041; G06K 9/00

(52) U.S. Cl. CPC G02B 27/0172; G06K 9/00597; G06T 19/006; G06F 3/0416; G02B 2027/014; G02B 2027/0138

(57) ABSTRACT

An display apparatus includes a mounting section configured to be mounted on the user, an image display unit that is provided in the mounting section and includes a right light guide plate and a left light guide plate that cause image light representing an image to be incident on the user's eyes when the mounting section is mounted on the user, a camera, an image analysis section that detects the matching state of the user's eyes relative to the right light guide plate and the left light guide plate based on an image captured with the camera when the mounting section is mounted on the user, and an adjustment control section that adjusts the image display unit or the right light guide plate and the left light guide plate based on the matching state detected by the image analysis section.

The entire disclosure of Japanese Patent Application No. 2014-218236 is expressly incorporated by reference herein.

### BACKGROUND

1. Technical Field

The present invention relates to a display apparatus and a method for controlling the display apparatus.

2. Related Art

There is a known display apparatus of related art called a head mounted display (HMD) mounted on a user's head when used.

### SUMMARY

A display apparatus of this type may be problematic in that a displayed image is difficult to be visually recognized when the mount position is shifted from a standard position. To overcome the difficulty, there is a proposed method of related art for capturing an image of a user's inner canthi and eyeballs with a camera and measuring the positions of the inner and outer canthi relative to the display to detect positional shift of the display (see Japanese Patent No. 5,414,946, for example). There is another proposed method of related art for attaching a mark to an HMD mounted on a user who faces a mirror and causing the HMD to capture an image on the mirror to adjust the image display position based on the mark in the captured image (see International Publication WO2013/145147, for example).

In the methods of related art described above, it is necessary to provide a camera that captures an image of a user's inner canthi and eyeballs, a mark attached to an HMD, or other types of equipment for position detection, undesirably resulting in a complicated configuration of the apparatus and a large burden on the user who performs the position detection.

An advantage of some aspects of the invention is to allow a user on whom a display apparatus is mounted to view an image in a preferable condition without any increase in burden on the user.

A display apparatus according to an aspect of the invention includes amounting section configured to be mounted on a user, a display section provided in the mounting section and including an optical element that causes image light representing an image to be incident on a user's eye when the mounting section is mounted on the user, an imaging section provided in the mounting section, a processing section that detects a matching state of the user's eye relative to the optical element based on an image captured with the imaging section when the mounting section is mounted on the user, and an adjustment control section that adjusts the display section or the optical element based on the matching state detected by the processing section.

According to the aspect of the invention, when the display apparatus is mounted on the user, the user can visually recognize an image in a preferable condition because the display apparatus detects the matching state of the user's eyes relative to the optical element and performs adjustment of the matching state.

In the display apparatus according to another aspect of the invention, the processing section detects the position of the optical element relative to the eye based on the image captured with the imaging section, and the adjustment control section adjusts the display section or the optical element based on the relative position of the optical element relative to the eye detected by the processing section so that the position of the image matches with the eye.

According to the aspect of the invention with this configuration, since the adjustment is performed based on the position of the user's eyes relative to the optical element, the user can visually recognize the image in a preferable condition even when the display apparatus is not mounted in an optimum position or at an optimum angle.

In the display apparatus according to another aspect of the invention, the display section includes a light output section that that outputs the image light to the optical element, the optical element has a reflection surface that reflects the image light incident from the light output section toward the user's eye, and the processing section detects the matching state of the positions of the user's eye relative to the position of the reflection surface.

According to the aspect of the invention with this configuration, since the matching state of the position of reflection surface provided in the optical element relative to the positions of the user's eyes, the position of the image light incident on the user's eyes can be adjusted in an appropriate position.

In the display apparatus according to another aspect of the invention, the imaging section performs imaging in the direction of the user's line of sight when the mounting section is mounted on the user, and the processing section detects the user and the display section or the optical element reflected in a light reflector located in the direction of the user's line of sight from the image captured with the imaging section to detect the matching state of the user's eye relative to the optical element.

According to the aspect of the invention with this configuration, since the imaging section that can be used for purposes other than the adjustment is used, the apparatus configuration for the adjustment is not complicated.

In the display apparatus according to another aspect of the invention, the processing section detects the user's eye and the optical element reflected in the light reflector to detect the matching state of the positions of the user's eye relative to the position of the optical element.

According to the aspect of the invention with this configuration, the image seen in the light reflector can be used to perform the adjustment more appropriately.

A controlling method for a display apparatus according to another aspect of the invention, the display apparatus including a mounting section configured to be mounted on a user and provided with a display section and an imaging section, the display section including an optical element that causes image light representing an image to be incident on the user's eye when the mounting section is mounted on the user, includes detecting a matching state of the user's eye relative to the optical element based on an image captured with the imaging section when the mounting section is mounted on the user and adjusting the display section or the optical element based on the detected matching state.

According to the aspect of the invention, when the display apparatus is mounted on the user, the user can visually recognize an image in a preferable condition because the method allows detection of the matching state of the user's eyes relative to the optical element and adjustment of the matching state.

### BRIEF DESCRIPTION OF THE DRAWINGS

The invention will be described with reference to the accompanying drawings, wherein like numbers reference like elements.

FIG. 1 is a descriptive diagram showing an exterior configuration of a head mounted display.

FIG. 2 shows the configuration of an optical system of an image display unit.

FIG. 3 is a functional block diagram of portions that form the head mounted display.

FIGS. 4A and 4B are plan views showing the positions of a user's eyes relative to the position of a displayed image.

FIGS. 5A and 5B are side views showing the positions of the user's eyes relative to the position of an object.

FIG. 6 is a flowchart showing the action of the head mounted display in an adjustment process.

FIG. 7 shows an example of the state of the user in the adjustment process.

FIG. 8 is a front view showing an example of the positions of the user's eyes relative to the positions of half-silvered mirrors.

### DESCRIPTION OF EXEMPLARY EMBODIMENTS

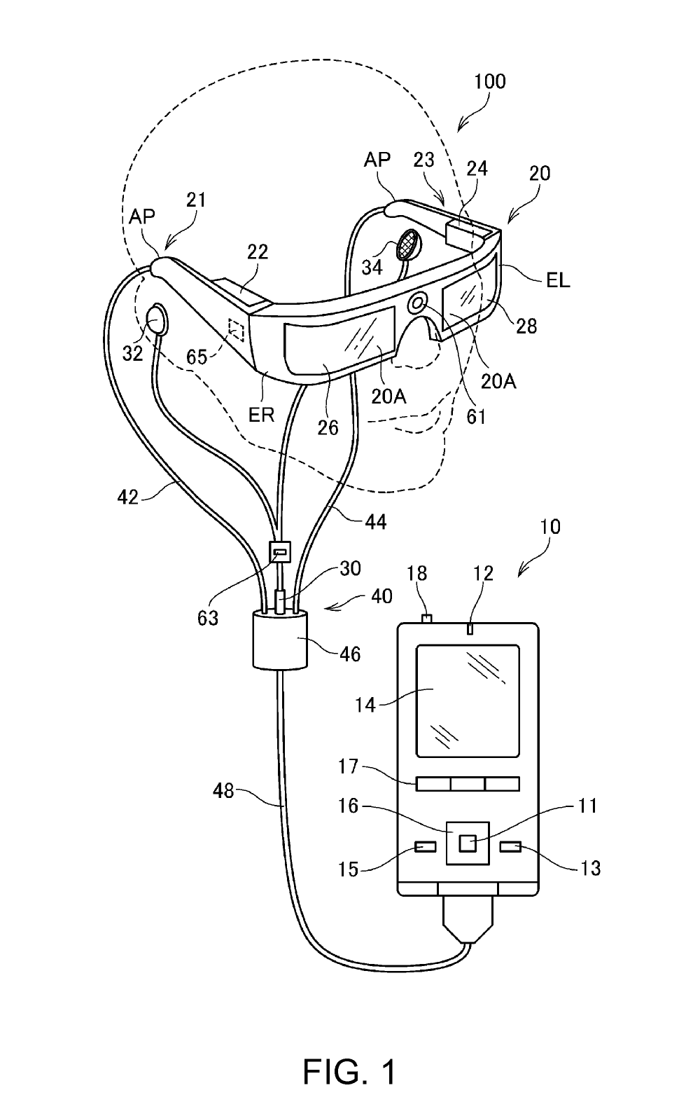

FIG. 1 is a descriptive diagram showing an exterior configuration of a head mounted display 100 (display apparatus) according to an embodiment to which the invention is applied.

The head mounted display 100 includes an image display unit 20, which is mounted on a user's head and allows the user to recognize a virtual image, and a control unit 10, which controls the image display unit 20. The control unit 10 also functions as a controller that allows the user to operate the head mounted display 100.

The image display unit 20 has a mountable structure to be mounted on the user's head and has a spectacle-like shape in the present embodiment. The image display unit 20 includes a right holder 21, a right display driver 22 (light output section), a left holder 23, a left display driver 24 (light output section), a right optical image display section 26, a left optical image display section 28, a camera 61 (imaging section), and a microphone 63. The right optical image display section 26 and the left optical image display section 28 are so disposed that they are located in front of the right and left eyes of the user on whom the image display unit 20 is mounted. One end of the right optical image display section 26 and one end of the left optical image display section 28 are connected to each other in a position corresponding to the portion between the eyes of the user on whom the image display unit 20 is mounted.

The right holder 21 is a member extending from an end ER of the right optical image display section 26, which is the other end thereof, to a position corresponding to a temporal region of the user on whom the image display unit 20 is mounted. Similarly, the left holder 23 is a member extending from an end EL of the left optical image display section 28, which is the other end thereof, to a position corresponding to another temporal region of the user on whom the image display unit 20 is mounted. The right holder 21 and the left holder 23, which serve in the same manner as temples (bows) of spectacles do, hold the image display unit 20 around the user's head.

The right display driver 22 and the left display driver 24 are disposed on opposite sides of the head of the user on whom the image display unit 20 is mounted. The right display driver 22 and the left display driver 24 are also simply called “display drivers” in a generic manner, and the right optical image display section 26 and the left optical image display section 28 are also simply called “optical image display sections” in a generic manner.

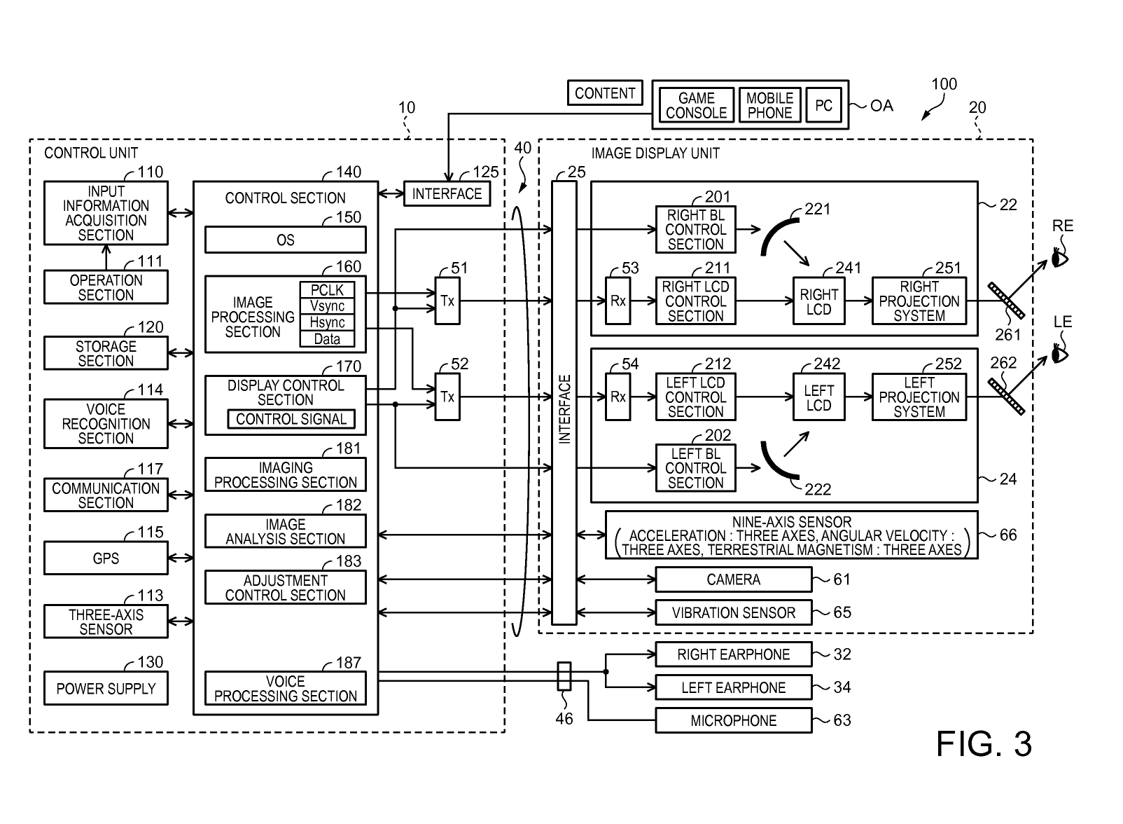

The display drivers 22 and 24 include liquid crystal displays 241 and 242 (hereinafter referred to as “LCDs 241 and 242”), projection systems 251 and 252, which will be described later with reference to FIG. 3, and other components.

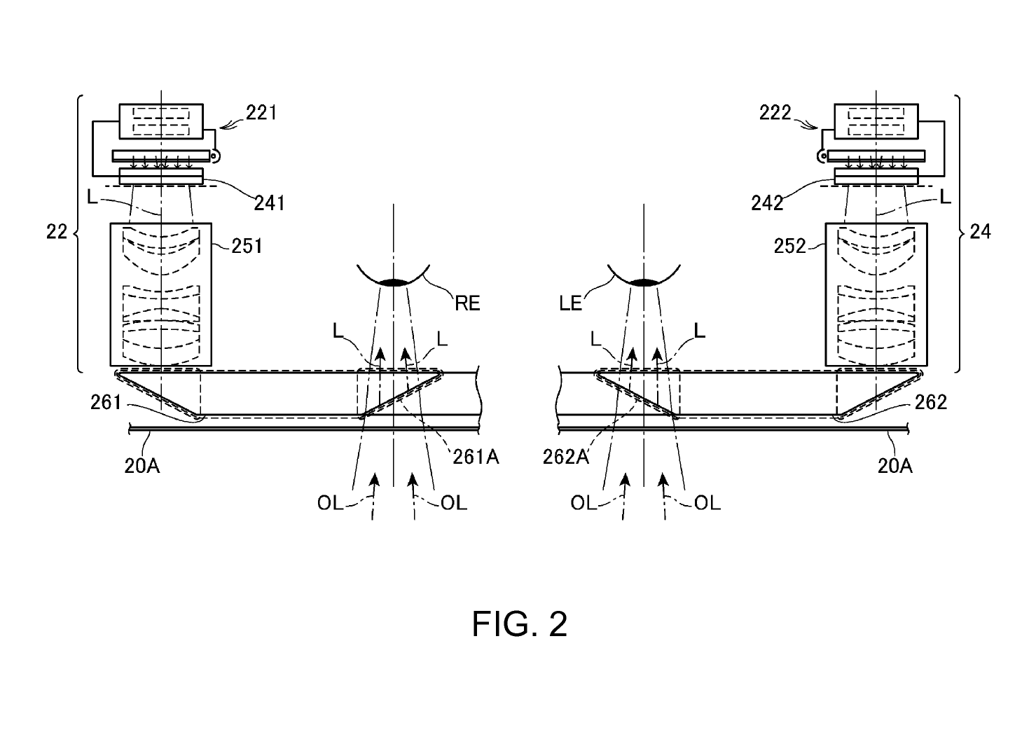

The right and left optical image display sections 26 and 28 include light guide plates 261 and 262 (FIG. 2) and light control plates 20A. The light guide plates 261 and 262 are made, for example, of a light transmissive resin and guide image light outputted from the display drivers 22 and 24 to the user's eyes. The light control plates 20A are each a thin-plate-shaped optical element and are so disposed that they cover the front side of the image display unit 20 that is opposite the side where the user's eyes are present. Each of the light control plates 20A can be a plate having light transmittance of substantially zero, a nearly transparent plate, a plate that transmits light but attenuates the amount of light, a plate that attenuates or reflects light of a specific wavelength, or any of other variety of optical components. Appropriate selection of optical characteristics (such as light transmittance) of the light control plates 20A allows adjustment of the amount of outside light incident from the outside on the right optical image display section 26 and the left optical image display section 28 and hence adjustment of visibility of a virtual image. In the present embodiment, a description will be made of a case where the light control plates 20A are optically transmissive enough to allow the user on whom the head mounted display 100 is mounted to visually recognize at least an outside scene. The light control plates 20A also protect the right light guide plate 261 and the left light guide plate 262 and prevent damage to the right light guide plate 261 and the left light guide plate 262, dirt from adhering thereto, and other defects from occurring.

The light control plates 20A may be configured to be attachable to and detachable from the right optical image display section 26 and the left optical image display section 28, or a plurality of types of light control plates 20A may be exchangeably attachable. The light control plates 20A may even be omitted.

The camera 61 is disposed at the boundary between the right optical image display section 26 and the left optical image display section 28. In a state in which the image display unit 20 is mounted on the user, the position of the camera 61 is roughly at the middle of the user's both eyes in the horizontal direction but above the user's both eyes in the vertical direction. The camera 61 is a digital camera including an imaging device, such as a CCD or CMOS device, an imaging lens, and other components but may instead be a monocular camera or a stereoscopic camera.

The camera 61 captures an image of at least part of an outside scene in the outward direction from the front side of the head mounted display 100, in other words, in the direction of the field of view of the user on whom the head mounted display 100 is mounted. The range of the angle of view of the camera 61 can be set as appropriate, and it is preferable that the image capturing range of the camera 61 covers the outside visually recognized by the user through the right optical image display section 26 and the left optical image display section 28. Further, it is more preferable that the image capturing range of the camera 61 is so set that the camera 61 can capture an image of the entire field of view of the user through the light control plates 20A.

The camera 61 performs the image capturing under the control of an imaging processing section 181 (FIG. 3) provided in a control section 140 and outputs captured image data to the imaging processing section 181.

FIG. 2 is a key part plan view showing the configuration of an optical system provided in the image display unit 20. FIG. 2 shows the user's left eye LE and right eye RE for ease of description.

The left display driver 24 includes a left backlight 222, which has a light source, such as an LED, and a diffuser, the left LCD 242, which is a transmissive LCD and disposed on the optical path of light emitted from the diffuser in the left backlight 222, and the left projection system 252, which includes a group of lenses that guide image light L having passed through the left LCD 242 and other components. The left LCD 242 is a transmissive liquid crystal panel having a plurality of pixels arranged in a matrix.

The left projection system 252 includes a collimator lens that converts the image light L outputted from the left LCD 242 into a parallelized light flux. The image light L having been converted into a parallelized light flux by the collimator lens is incident on the left light guide plate 262 (optical element). The left light guide plate 262 is a prism having a plurality of reflection surfaces that reflect the image light L, and the image light L undergoes reflection multiple times in the left light guide plate 262 and is guided toward the left eye LE. In the left light guide plate 262 is formed a half-silvered mirror 262A (reflection surface) in a position in front of the left eye LE.

The image light L reflected off the half-silvered mirror 262A exits out of the left optical image display section 28 toward the left eye LE and forms an image on the retina of the left eye LE, and the image is visually recognized by the user.

The right display driver 22 is so configured that the right display driver 22 and the left display driver 24 are in bilateral symmetry. The right display driver 22 includes a right backlight 221, which has a light source, such as an LED, and a diffuser, the right LCD 241, which is a transmissive LCD and disposed on the optical path of light emitted from the diffuser in the right backlight 221, and the right projection system 251, which includes a group of lenses that guide image light L having passed through the right LCD 241 and other components. The right LCD 241 is a transmissive liquid crystal panel having a plurality of pixels arranged in a matrix.

The right projection system 251 includes a collimator lens that converts the image light L outputted from the right LCD 241 into a parallelized light flux. The image light L having been converted into a parallelized light flux by the collimator lens is incident on the right light guide plate 261 (optical element). The right light guide plate 261 is a prism having a plurality of reflection surfaces that reflect the image light L, and the image light L undergoes reflection multiple times in the right light guide plate 261 and is guided toward the right eye RE. In the right light guide plate 261 is formed a half-silvered mirror 261A (reflection surface) in a position in front of the right eye RE.

The image light L reflected off the half-silvered mirror 261A exits out of the right optical image display section 26 toward the right eye RE and forms an image on the retina of the right eye RE, and the image is visually recognized by the user.

On the user's right eye RE is incident the image light L reflected off the half-silvered mirror 261A and outside light OL having passed through the corresponding light control plate 20A. On the user's left eye LE is incident the image light L reflected off the half-silvered mirror 262A and the outside light OL having passed through the corresponding light control plate 20A. The head mounted display 100 thus causes the image light L carrying an image processed in the head mounted display 100 and the outside light OL superimposed on each other to be incident on the user's eyes, whereby the user views an outside scene through the light control plates 20A and visually recognizes the image carried on the image light L and superimposed on the outside scene. The head mounted display 100 thus functions as a see-through-type display apparatus.

The left projection system 252 and the left light guide plate 262 are also collectively referred to as a “left light guide unit,” and the right projection system 251 and the right light guide plate 261 are also collectively referred to as a “right light guide unit.” The configuration of the right and left light guide units is not limited to the example described above and can be arbitrarily configured as long as the image light is used to form a virtual image in a position in front of the user's eyes. For example, a diffraction grating may be used, or a half-transmissive/reflective film may be used.

The image display unit 20 is connected to the control unit 10 via a connection section 40. The connection section 40 includes a body cord 48, which is connected to the control unit 10, a right cord 42, a left cord 44, and a connection member 46. The right cord 42 and the left cord 44 are two cords into which the body cord 48 bifurcates. The right cord 42 is inserted into an enclosure of the right holder 21 through a lengthwise end portion AP of the right holder 21 and connected to the right display driver 22. Similarly, the left cord 44 is inserted into an enclosure of the left holder 23 through a lengthwise end portion AP of the left holder 23 and connected to the left display driver 24.

The connection member 46 is disposed at the point where the body cord 48 bifurcates into the right cord 42 and the left cord 44 and has a jack for connecting an earphone plug 30. A right earphone 32 and a left earphone 34 extend from the earphone plug 30. The microphone 63 is provided in a position in the vicinity of the earphone plug 30. An integrated single code extends from the earphone plug 30 to the microphone 63 and bifurcates at the microphone 63 into two codes connected to the right earphone 32 and the left earphone 34, respectively.

The microphone 63 is so disposed that a sound collection section of the microphone 63 faces in the directions of the sight lines of the user as shown, for example, in FIG. 1, collects voice, and outputs a voice signal to a voice processing section 187 (FIG. 3). The microphone 63 may, for example, be a monaural microphone, a stereo microphone, a directional microphone, or an omni-directional microphone.

Each of the right cord 42, the left cord 44, and the body cord 48 may be any cord capable of transmitting digital data and can be formed, for example, of a metal cable or an optical fiber. The right cord 42 and the left cord 44 may instead be integrated with each other into a single cord.

The image display unit 20 and the control unit 10 transmit a variety of signals to each other via the connection section 40. Connectors (not shown) that engage with each other are provided at the end of the body cord 48 that is opposite the end where the connection member 46 is present and at an end of the control unit 10. Causing the connectors at the body cord 48 and the control unit 10 to engage with each other or disengage from each other allows the control unit 10 and the image display unit 20 to be connected to each other or disconnected from each other.

The control unit 10 controls the head mounted display 100. The control unit 10 has a group of switches including a finalizing key 11, a lighting portion 12, a display switch key 13, a luminance switch key 15, a direction key 16, a menu key 17, and a power switch 18. The control unit 10 further includes a track pad 14, which is operated by the user with a finger of the user' hand.

The finalizing key 11 detects the user's pressing operation and outputs a signal that finalizes action corresponding to the operation performed on the control unit 10. The lighting portion 12 includes a light source, such as an LED (light emitting diode), and notifies the user of the state of action of the head mounted display 100 (whether it is powered on or off, for example) in the form of the lighting state of the light source. The display switch key 13 outputs a signal that instructs, for example, switching of an image display mode in response to the user's pressing operation.

The track pad 14 has an operation surface that detects contact operation and outputs an operation signal in accordance with operation performed on the operation surface. A method for detecting operation performed on the operation surface is not limited to a specific method and can, for example, be an electrostatic method, a pressure detection method, and an optical method. The luminance switch key 15 outputs a signal that instructs increase or decrease in the luminance of the image display unit 20 in response to the user's pressing operation. The direction key 16 outputs an operation signal in response to the user's pressing operation of a key corresponding to any of the upward, downward, rightward, and leftward directions. The power switch 18 powers on and off the head mounted display 100.

FIG. 3 is a functional block diagram of sections that the head mounted display 100 includes.

The head mounted display 100 includes an interface 125 that connects a variety of external apparatus OA, which are content supply sources, to the head mounted display 100. The interface 125 may be a wired connection interface, such as a USB interface, a micro-USB interface, and a memory card interface, or a wireless communication interface. Each of the external apparatus OA is an image supply apparatus that supplies the head mounted display 100 with images and may, for example, be a personal computer (PC), a mobile phone terminal, and a mobile game console.

The control unit 10 includes a control section 140, an input information acquisition section 110, a storage section 120, a transmitter (Tx) 51, and a transmitter (Tx) 52.

The input information acquisition section 110 is connected to an operation section 111. The operation section 111 includes the track pad 14, the direction key 16, and the power switch 18, and the other components described above, and based on a signal inputted from the operation section 111, the input information acquisition section 110 acquires an inputted content. The control unit 10 further includes a power supply (not shown) that supplies the sections in the control unit 10 and the image display unit 20 with electric power.

The storage section 120 is a nonvolatile storage device and stores a variety of computer programs and data associated with the programs. The storage section 120 may store data of still images and motion images to be displayed in the image display unit 20.

The storage section 120 stores setting data 121. The setting data 121 contains a variety of setting values used by an image analysis section 182 and an adjustment control section 183, which will be described later. Each of the setting vales contained in the setting data 121 may be a value having been inputted in advance through operation performed on the operation section 111 or a setting value received from any of the external apparatus OA or any other apparatus (not shown) via a communication section 117 or the interface 125 and stored in the storage section 120.

A three-axis sensor 113, a GPS 115, a communication section 117, and a voice recognition section 114 are connected to the control section 140. The three-axis sensor 113 is a three-axis acceleration sensor, and the control section 140 acquires values detected with the three-axis sensor 113. The GPS 115 includes an antenna (not shown), receives GPS (global positioning system) signals, and calculates the current position of the control unit 10. The GPS 115 outputs the current position and current time determined based on the GPS signals to the control section 140. The GPS 115 may further have a function of acquiring the current time based on information contained in the GPS signals and correcting the time clocked by the control section 140.

The communication section 117 performs wireless data communication that complies with wireless LAN (WiFi (registered trademark)), Miracast (registered trademark), Bluetooth (registered trademark), or any other standard.

When any of the external apparatus OA is wirelessly connected to the communication section 117, the control section 140 acquires content data via the communication section 117 and causes the image display unit 20 to display an image. On the other hand, when any of the external apparatus OA is wired to the interface 125, the control section 140 acquires content data via the interface 125 and causes the image display unit 20 to display an image. The communication section 117 and the interface 125 function as a data acquisition section DA, which acquires content data from the external apparatus OA.

The control section 140 includes a CPU (not shown) that executes a program, a RAM (not shown) that temporarily stores the program executed by the CPU and data used by the CPU, and a ROM (not shown) that stores a basic control program executed by the CPU and data used by the CPU in a nonvolatile manner. The control section 140 reads and executes a computer program stored in the storage section 120 to function as an operating system (OS) 150, an image processing section 160, a display control section 170, an imaging processing section 181, an image analysis section 182 (processing section), an adjustment control section 183, and a voice processing section 187.

The image processing section 160 acquires an image signal contained in contents. The image processing section 160 separates a vertical sync signal VSync, a horizontal sync signal HSync, and other sync signals from the acquired image signal. Further, the image processing section 160 generates a clock signal PCLK, for example, by using a PLL (phase locked loop) circuit (not shown) in accordance with the cycles of the separated vertical sync signal VSync and horizontal sync signal HSync. The image processing section 160 converts the analog image signal from which the sync signals have been separated into a digital image signal, for example, by using an A/D conversion circuit (not shown). The image processing section 160 stores the converted digital image signal as image data (Data in FIG. 3) representing images included in the contents in the RAM in the control section 140 for every frame period. The image data is, for example, RGB data.

The image processing section 160 may perform, as required, resolution conversion in which the resolution of the image data is converted into resolution suitable for the right display driver 22 and the left display driver 24. Further, the image processing section 160 may perform image adjustment in which luminance and chroma of the image data is adjusted, 2D/3D conversion in which 2D image data is created from 3D image data or 3D image data is created from 2D image data, and other types of processing.

The image processing section 160 transmits via the transmitters 51 and 52 the clock signal PCLK, the vertical sync signal VSync, the horizontal sync signal HSync, and the image data “Data” stored in the RAM. Each of the transmitters 51 and 52 functions as a transceiver and performs serial transmission between the control unit 10 and the image display unit 20. The image data “Data” transmitted via the transmitter 51 is called “image data for the right eye,” and the image data “Data” transmitted via the transmitter 52 is called “image data for the left eye.”

The display control section 170 generates control signals that control the right display driver 22 and the left display driver 24, and controls, via the control signals, each of the right display driver 22 and the left display driver 24 to cause it to generate and output image light. Specifically, the display control section 170 controls a right LCD control section 211 to cause it to drive the right LCD 241 or not and controls a right backlight control section 201 to drive the right backlight 221 or not. Further, the display control section 170 controls a left LCD control section 212 to drive the left LCD 242 or not and controls a left backlight control section 202 to drive the left backlight 222 or not.

The image processing section 160 and the display control section 170 have a function of changing the position of an image displayed in each of the right LCD 241 and the left LCD 242 under the control of the adjustment control section 183, which will be described later. Specifically, when the adjustment control section 183 generates control data showing the amount of shift and the direction of the shift in accordance with which the display position is shifted, the image processing section 160 shifts image data in accordance with the control data. The display control section 170 controls the right LCD control section 211 and the left LCD control section 212 in accordance with the control data generated by the adjustment control section 183 to cause them to shift the positions of images displayed in the right LCD 241 and the left LCD 242.

Further, the image processing section 160 and the display control section 170 has a function of changing the size of an image displayed in the right LCD 241 and the left LCD 242 under the control of the adjustment control section 183, which will be described later. Specifically, when the adjustment control section 183 generates control data specifying the display size, the image processing section 160 enlarges or reduces image data in accordance with the control data. The display control section 170 controls the right LCD control section 211 and the left LCD control section 212 in accordance with the control data generated by the adjustment control section 183 to cause them to enlarge or reduce the size of images displayed in the right LCD 241 and the left LCD 242.

One of the image processing section 160 and the display control section 170 may instead carry out the processes described above to change the display positions. Still instead, both the image processing section 160 and the display control section 170 may carry out the processes described above. In this case, the adjustment control section 183 may generate control data corresponding to each of the image processing section 160 and the display control section 170.

The voice processing section 187 acquires a voice signal contained in contents, amplifies the acquired voice signal, and outputs the amplified voice signal to the right earphone 32 and the left earphone 34. The voice processing section 187 further acquires voice collected with the microphone 63 and converts the collected voice into digital voice data. The voice processing section 187 may perform preset processing on the digital voice data.

The image display unit 20 includes an interface 25, the right display driver 22, the left display driver 24, the right light guide plate 261 as the right optical image display section 26, the left light guide plate 262 as the left optical image display section 28, the camera 61, a vibration sensor 65, and a nine-axis sensor 66.

The vibration sensor 65 is formed of an acceleration sensor and built, for example, in the right holder 21 and in a portion in the vicinity of the end ER of the right optical image display section 26, as shown in FIG. 1. The vibration sensor 65 detects vibration produced when the user knocks the end ER (performs knock operation) and outputs a result of the detection to the control section 140. Based on a result of the detection performed by the vibration sensor 65, the control section 140 detects the knock operation performed by the user.

The nine-axis sensor 66 is a motion sensor that detects acceleration (three axes), angular velocity (three axes), and terrestrial magnetism (three axes). When the image display unit 20 is mounted on the user's head, the control section 140 can detect motion of the user's head based on detected values from the nine-axis sensor 66. For example, the control section 140 can estimate the magnitude and direction of inclination of the image display unit 20 based on a detected value from the nine-axis sensor 66.

The interface 25 includes a connector to which the right cord 42 and the left cord 44 are connected. The interface 25 outputs the clock signal PCLK, the vertical sync signal VSync, the horizontal sync signal HSync, and the image data “Data” transmitted from the transmitters 51 and 52 to the corresponding receivers (Rx) 53 and 54. The interface 25 further outputs control signals transmitted from the display control section 170 to the corresponding receivers 53 and 54 and the corresponding right backlight control section 201 and left backlight control section 202.

Further, the interface 25 is an interface to which the camera 61, the vibration sensor 65, and the nine-axis sensor 66 are connected. A vibration detection result from the vibration sensor 65 and acceleration (three axes), angular velocity (three axes), and terrestrial magnetism (three axes) detection results from the nine-axis sensor 66 are sent via the interface 25 to the control section 140.

The right display driver 22 includes the right backlight 221, the right LCD 241, and the right projection system 251 described above. The right display driver 22 further includes the receiver 53, the right backlight (BL) control section 201, which controls the right backlight (BL) 221, and the right LCD control section 211, which controls the right LCD 241.

The receiver 53 operates as a receiver corresponding to the transmitter 51 and performs serial transmission between the control unit 10 and the image display unit 20. The right backlight control section 201 drives the right backlight 221 based on the inputted control signal. The right LCD control section 211 drives the right LCD 241 based on the clock signal PCLK, the vertical sync signal VSync, the horizontal sync signal HSync, and the image data “Data” for the right eye, which are inputted via the receiver 53.

The left display driver 24 has the same configuration as that of the right display driver 22. The left display driver 24 includes the left backlight 222, the left LCD 242, and the left projection system 252 described above. The left display driver 24 further includes the receiver 54, the left backlight control section 202, which drives the left backlight 222, and the left LCD control section 212, which controls the left LCD 242.

The receiver 54 operates as a receiver corresponding to the transmitter 52 and performs serial transmission between the control unit 10 and the image display unit 20. The left backlight control section 202 drives the left backlight 222 based on the inputted control signal. The left LCD control section 212 drives the left LCD 242 based on the clock signal PCLK, the vertical sync signal VSync, the horizontal sync signal HSync, and the image data “Data” for the left eye, which are inputted via the receiver 54.

The right backlight control section 201, the right LCD control section 211, the right backlight 221, and the right LCD 241 are also collectively referred to as a right “image light generation section.” Similarly, the left backlight control section 202, the left LCD control section 212, the left backlight 222, and the left LCD 242 are also collectively referred to as a left “image light generation section.”

When the user on whom the head mounted display 100 is mounted views an image, but when the positions of the user's eyes do not match with the position of the image light L, which the right light guide plate 261 and the left light guide plate 262 cause to be incident on the user's eyes, the image viewed by the user is affected.

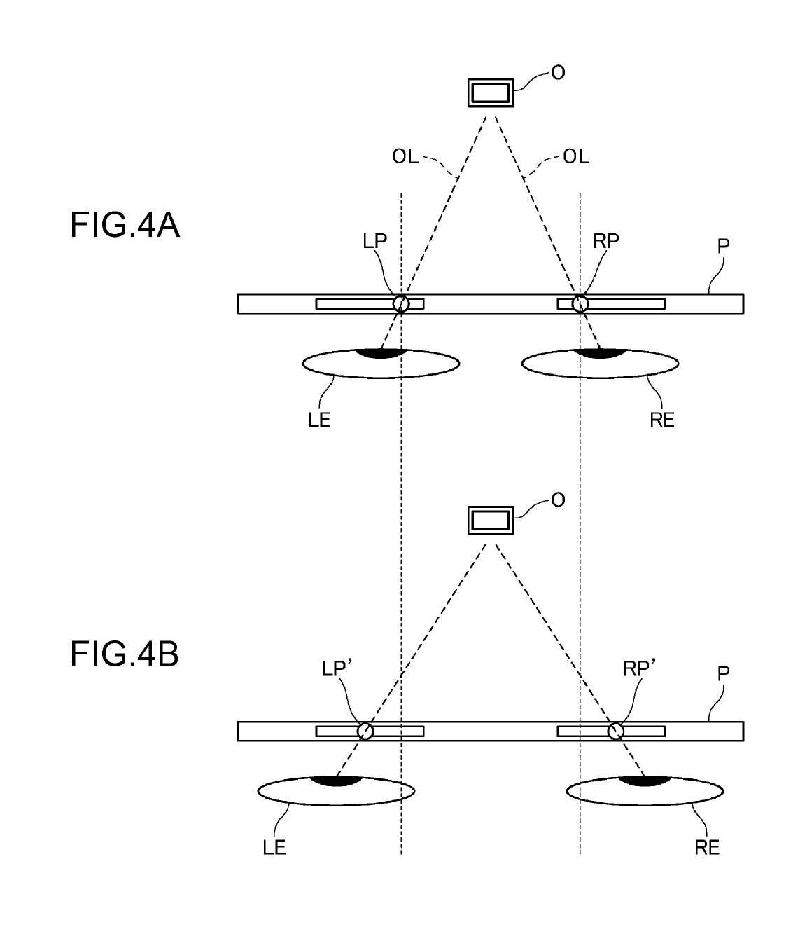

FIGS. 4A and 4B are descriptive diagrams showing the positions of the user's eyes relative to the position of the image display unit 20 in a plan view. In particular, FIGS. 4A and 4B show an effect of the positions of the user's both eyes in the rightward/leftward direction.

FIGS. 4A and 4B show a case where the image display unit 20 is mounted on the user's head and the user visually recognizes an object O located in front of the user. The image display unit 20 allows the user to visually recognize an image that provides an AR (augmented reality) effect (hereinafter referred to as AR image). The user not only visually recognizes the object O actually present in front of the user through the right light guide plate 261, the left light guide plate 262, and the light control plates 20A but also visually recognizes the AR image. The AR effect is provided when the AR image perceived or viewed as being superimposed on the object O by the user.

The image display unit 20 causes the image light L to be incident on the user's eyes via the right light guide plate 261 and the left light guide plate 262 to allow the user to visually recognize the AR image. The AR image visually recognized by the user is not a real image formed on the right light guide plate 261 or the left light guide plate 262 but is a virtual image formed in the eyes by the image light L. In FIGS. 4A and 4B, a reference character P denotes a display position of the virtual image produced by the image display unit 20 but considered as a real image. In other words, displaying an image (real image) in the image display position P can be considered equivalent to producing the virtual image with the image display unit 20.

Since the image display positions P (LP and RP) are positions on imaginary axis lines that connect the user's both eyes to the object O and are determined by the positions of the half-silvered mirrors 261A and 262A, the image display positions P in FIGS. 4A and 4B correspond to the common point on the object.

When the user visually recognizes the object O, the outside light OL is incident from the object O on each of the right eye RE and the left eye LE, as shown in FIG. 4A. In this case, the right eye RE visually recognizes part of an image displayed in the image display position P, specifically, an AR image in a position RP with the AR image superimposed or overlaid on the object O. Similarly, the left eye LE visually recognizes part of the image displayed in the image display position P, specifically, an AR image in a position LP with the AR image superimposed or overlaid on the object O.

Therefore, when the head mounted display 100 displays an AR image in the positions RP and LP, the AR image is superimposed or overlaid on the object O, whereby the AR effect can be sufficiently provided.

FIG. 4B shows a case where the distance between the user's right eye RE and left eye LE is greater than the distance in the case shown in FIG. 4A. The distance between a user's right eye RE and left eye LE varies on an individual basis due, for example, to the user's skeletal structure. When a person having a large distance between the right eye RE and the left eye LE uses the head mounted display 100, the state shown in FIG. 4B is achieved. In the case shown in FIG. 4B, to display an AR image in such a way that the user visually recognizes the AR image superimposed or overlaid on the object O, the image is displayed in positions LP′ and RP′, which are shifted from LP and RP.

The following findings about the position of an AR image in the direction in which the user's both eyes are arranged are therefore provided: That is, to allow the user to visually recognize an AR image superimposed or overlaid on the object O, the display position of the AR image needs to be changed even when the positions of the object O, the user, and the image display unit 20 mounted on the user remain unchanged but when the positions of the right eye RE and the left eye LE change. In other words, the display positions of AR images in the rightward/leftward direction relative to the user's both eyes desirably correspond to the positions of the right eye RE and the left eye LE.

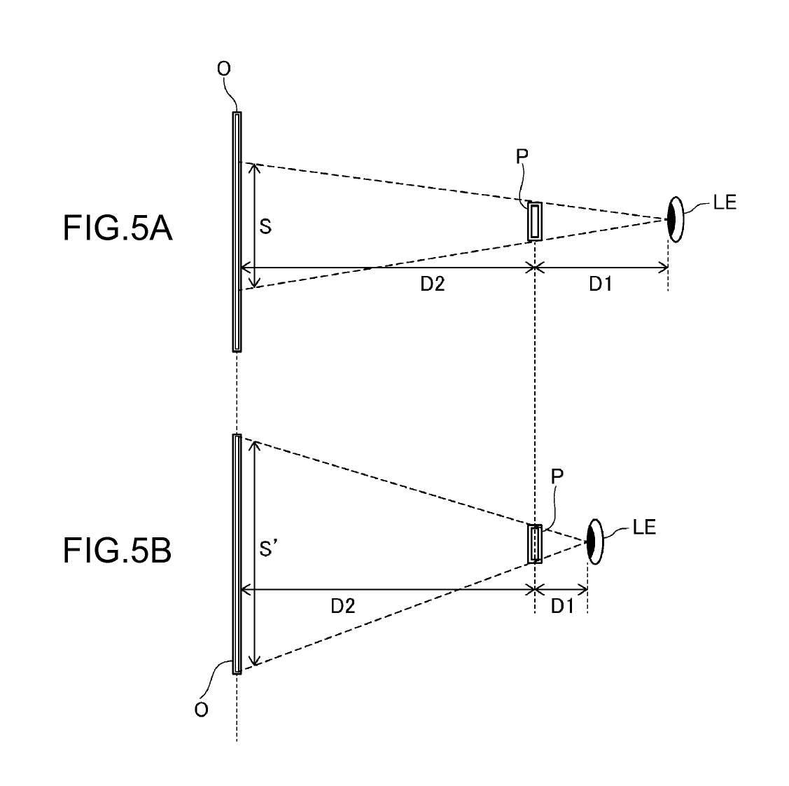

FIGS. 5A and 5B are descriptive diagrams showing the positions the user's eyes relative to the position of the object O in a side view. In particular, FIGS. 5A and 5B show an effect of the distance between the object O and the right eye RE/the left eye LE. FIGS. 5A and 5B show a case where the user is allowed to visually recognize an AR image superimposed on the object O located in front of the user, as in FIGS. 4A and 4B. Reference character P denotes the display position of a real image equivalent to the virtual image actually formed by the image display unit 20. FIGS. 5A and 5B are side views and show the user's left eye LE, and the AR image viewed with the user's right eye RE can be considered to be the same.

In these cases, the user visually recognizes an AR image superimposed on the object O. That is, the AR image is perceived as if it were located in the position of the object O in the depth direction. When the sizes of an image in the position of the object O that corresponds to the AR image displayed by the image display unit 20 are compared with each other, the size S of the image in the case shown in FIG. 5A is smaller than the size S′ of the image in the case shown in FIG. 5B.

The difference between the sizes S and S′ in the position of the object O is affected by the ratio of a distance D1 between the left eye LE and the image display position P to a distance D2 between the image display position P and the object O. For example, when the magnitude (length) of the distance D1 varies, the size of the AR image in the position of the object O varies, as shown in FIGS. 5A and 5B.

An AR image, when it is superimposed on the object O and the superimposed image is viewed, provides advantageous effects of providing the user with information that is not contained in an actual scene and allowing the user to visually recognize the object O in a way different from the way the actual scene is viewed. It is therefore desirable to set the visually recognized size of the AR image to be equal to the actual size of the object O. The head mounted display 100 therefore desirably adjusts the size of a displayed AR image in accordance with the distance D1 between the left eye LE and the image display position P and the distance D2 between the image display position P and the object O. The distance D1 between the image display position P and the left eye LE is roughly fixed in view of the shape and specifications of the image display unit 20. It is therefore expected that performing the adjustment at least in accordance with the distance D2 between the image display position P and the object O allows the user to visually recognize an AR image in an appropriate condition.

To this end, when the head mounted display 100 is mounted on the user and displays an AR image, the head mounted display 100 determines the positions of the user's right eye RE and left eye LE relative to the position of the image display unit 20 and adjusts the display position of the AR image accordingly. This function is achieved by an adjustment process carried out by the control section 140.

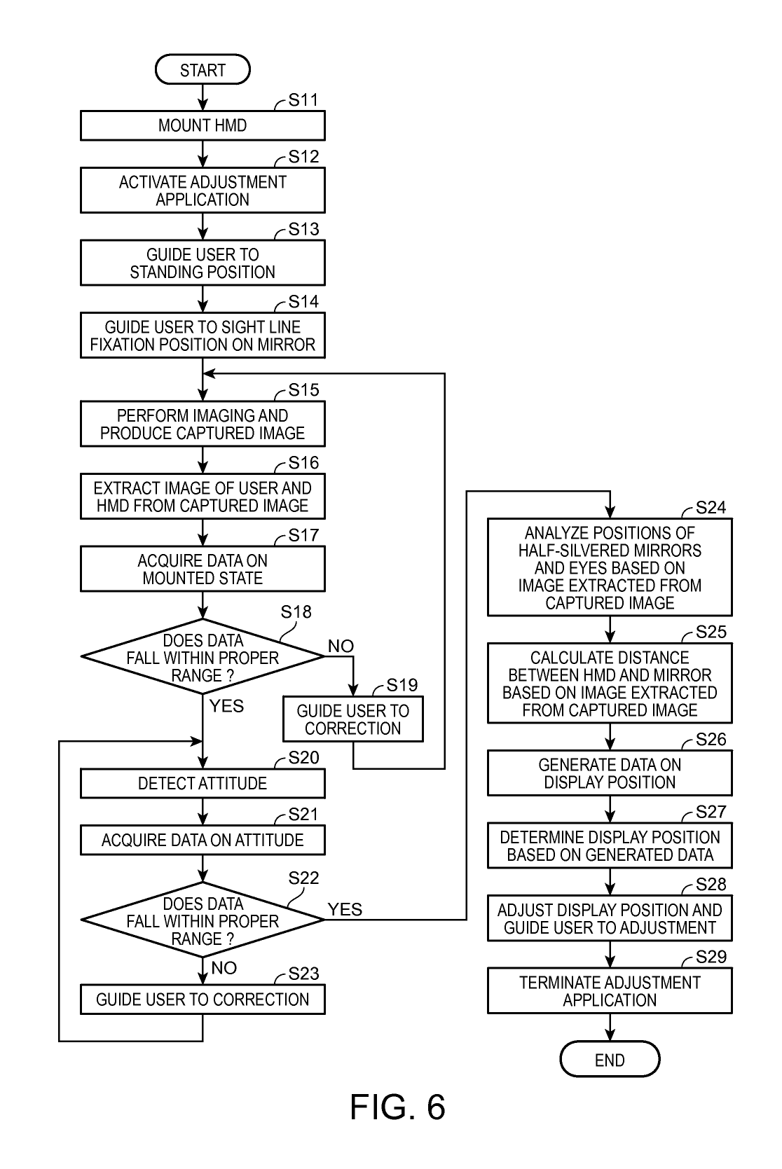

FIG. 6 is a flowchart showing the action of the head mounted display in the adjustment process.

The heat mounted display 100 is mounted on the user (step S11), and the user operates the operation section 111. In response to the user's operation of the operation section 111 to issue an instruction to start the adjustment process, the control section 140 reads and activates an adjustment application program stored in the storage section 120 (step S12). The function of the adjustment application program causes the imaging processing section 181, the image analysis section 182, and the adjustment control section 183 to start the adjustment process.

The adjustment control section 183 outputs image data for guiding purposes to the display control section 170 and causes the image display unit 20 to display an image that guides the user to a position where the user is required to stand for the adjustment (step S13).

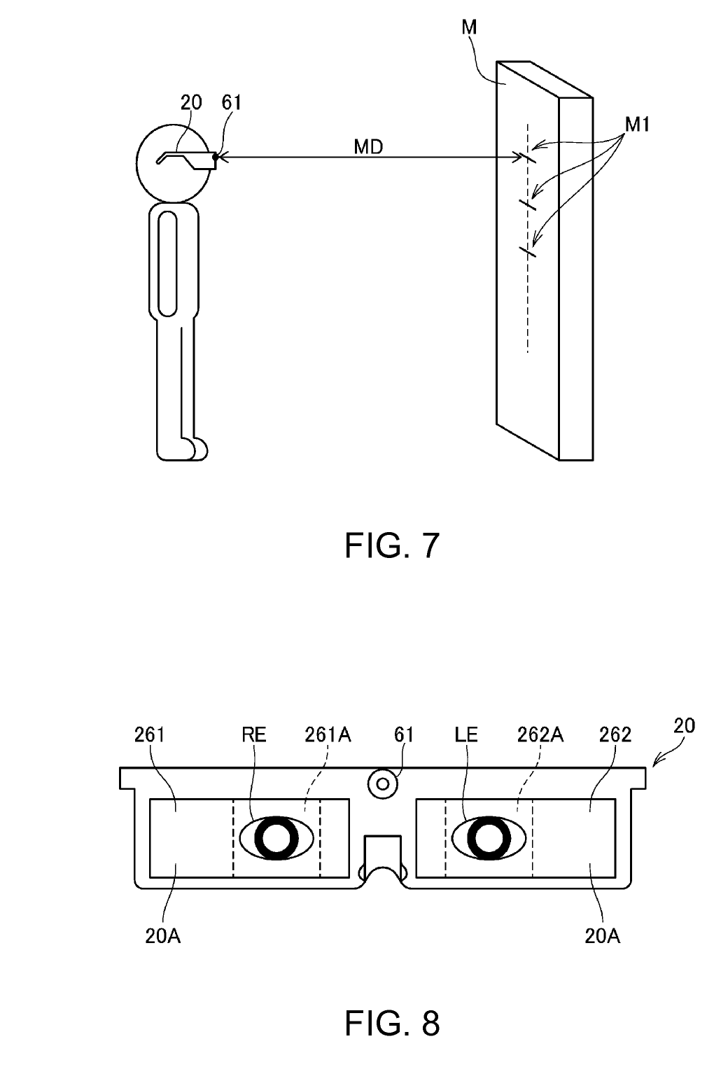

FIG. 7 shows an example of the state of the user in the adjustment process. In the adjustment process carried out by the head mounted display 100, the user stands in front of a mirror M, as shown in FIG. 7. The user preferably stands in front of the mirror M in such a way that the camera 61 can capture an image of the user seen or reflected in the mirror M.

The control section 140 detects the positions of the user's right eye RE and left eye LE from an image captured with the camera 61, as will be described later. It is therefore preferable that the user fixes the lines of sight on the mirror M from the front. To assist the user, a mark M1 indicating the position on which the user fixes the lines of sight may be placed on the mirror M. The mark M1 may be placed on the mirror M in a plurality of height positions in correspondence with height positions of users' right eye RE and the left eye LE.

The adjustment control section 183 outputs image data for adjustment purposes to the display control section 170 and causes the image display unit 20 to display an image that guides the user to the position on the mirror M on which the user fixes the lines of sight (step S14). For example, the adjustment control section 183 causes the image display unit 20 to display an image that specifies one of the marks M1 in FIG. 7 as the sight line fixation position. In a case where the user's height is inputted through the operation section 111, the adjustment control section 183 may calculate the height of a sight line fixation point suitable for the adjustment based on the inputted user's height and cause the image display unit 20 to display an image that specifies a mark M1 corresponding to the calculated height. The height of the sight line fixation point is preferably equal to the height of the user's right eye RE and left eye LE but may instead be the height of the camera 61.

The imaging processing section 181 subsequently controls the camera 61 to cause it to perform imaging to generate captured image data (step S15). The image analysis section 182 analyzes the captured image data generated by the imaging processing section 181 to extract an image of the user and the head mounted display 100 reflected in the mirror from the captured image data (step S16).

The image analysis section 182 acquires data on the mounted state of the head mounted display 100 based on the extracted image (step S17). That is, the image analysis section 182 calculates a straight line connecting the right holder 21 (FIG. 1) and the left holder 23 (FIG. 1) of the image display unit 20 to each other and a straight line representing the rightward/leftward direction of the user's head from the extracted image data and acquires data on the angle between the two calculated straight lines.

The adjustment control section 183 evaluates whether or not the data acquired by the image analysis section 182 falls within a proper range set in advance (step S18). Data representing the proper range is stored in the storage section 120 in advance as the setting data 121.

When the data on the mounted state does not fall within the proper range (NO in step S18), it can be considered that the inclination of the user's head does not agree with the inclination of the image display unit 20, that is, the image display unit 20 has not been properly mounted.

In this case, the adjustment control section 183 outputs image data for guiding purposes to the display control section 170 and causes the image display unit 20 to display an image that guides the user to correction of the mounted state of the head mounted display 100 (step S19). The control section 140 then returns to step 15 and performs imaging.

When the data on the mounted state falls within the proper range (YES in step S18), the adjustment control section 183 acquires a detection value from a sensor provided in the image display unit 20 (step S20) and calculates or acquires data on the user's attitude based on the acquired detected value (step S21). The adjustment control section 183 calculates data representing the inclination of the user's head with respect to the vertical direction based on a detected value of the acceleration detected with the nine-axis sensor 66.

The adjustment control section 183 evaluates whether or not the data acquired by the image analysis section 182 is a value that falls within a proper range set in advance (step S22). Data representing the proper range is stored in the storage section 120 in advance as the setting data 121.

When the data on the mounted state (the user's attitude) does not fall within the proper range (NO in step S22), the inclination of the image display unit 20, that is, the user's attitude can be considered not to be proper.

In this case, the adjustment control section 183 outputs image data for guiding purposes to the display control section 170 and causes the image display unit 20 to display an image that guides the user to correction of the attitude (step S23). The control section 140 then returns to step 20 and detects the attitude.

In steps S20 and S21, the adjustment control section 183 may detect the attitude to acquire data on the attitude based on the captured image data from the camera 61. In this case, the image analysis section 182 analyzes the captured image data to detect the inclination of the user's head or the inclination of the image display unit 20. For example, an image of the user's head or the image display unit 20 reflected in the mirror may be extracted from the captured image data to calculate the inclination of the user's head or the image display unit 20, or the edge of the mirror M may be detected from the captured image data to calculate the inclination of the camera 61 with respect to the height direction of the mirror M.

In the case where the method described above is used, the control section 140 carries out step S23 and then returns to step S15, where the control section 140 causes the camera 61 to perform imaging again.

When the data on the mounted state (the user's attitude) falls within the proper range (YES in step S22), the adjustment control section 183 adjusts the image display position and/or the image size.

The image analysis section 182 analyzes an image of the image display unit 20 reflected in the mirror and extracted from the captured image data to analyze the positions of the half-silvered mirrors 261A and 262A relative to the positions of the user's right eye RE and left eye LE (step S24).

FIG. 8 is a front view showing an example of the positions of the user's eyes relative to the positions of the half-silvered mirrors 261A and 262A.

The image analysis section 182 identifies the center positions of the half-silvered mirrors 261A and 262A based on an image of the image display unit 20 reflected in the mirror and extracted from the captured image data. The image analysis section 182 subsequently identifies the center position of the right eye RE and the center position of the left eye LE based on an image extracted from the same captured image data. In this process, the image analysis section 182 may calculate the identified positions in the form of coordinates in the captured image data.

The image analysis section 182 analyzes the position of the half-silvered mirror 261A relative to the position of the right eye RE and the position of the half-silvered mirror 262A relative to the position of the left eye LE based on the identified positions.

In this process, the image analysis section 182 may instead extract an image of the image display unit 20 reflected in the mirror from the captured image data and estimate and calculate the center positions of the half-silvered mirrors 261A and 262A based on the edge of the image of the image display unit 20 reflected in the mirror. The right light guide plate 261 and the left light guide plate 262 are securely attached to and positioned with respect to the right holder 21 and the left holder 23 of the image display unit 20. The positional relationship between the outer edge of the image display unit 20 and the center positions of the half-silvered mirrors 261A, 262A is therefore known based on the specifications of the image display unit 20. It is therefore unnecessary to extract the image itself of the half-silvered mirrors 261A and 262A reflected in the mirror from the captured image data. The positions of the half-silvered mirrors 261A and 262A can therefore be determined under no influence of optical characteristics of the right light guide plate 261, the left light guide plate 262, and the half-silvered mirrors 261A, 262A.

To eliminate an effect in a case where the user blinks and in a case where the user's eyes make eye-ball motion called saccade (or micro-saccade), the imaging processing section 181 may cause the camera 61 to perform imaging multiple times at different points of time. In this case, the image analysis section 182 may determine the position of the right eye RE and the position of the left eye LE based on each of the multiple sets of captured image data produced by the imaging processing section 181 and set the average of the positions determined from the entire captured image data to be the position of the right eye RE and the position of the left eye LE.

The image analysis section 182 then calculates the distance between the image display unit 20 and the mirror M based on the size of an image of the image display unit 20 reflected in the mirror and extracted from the captured image data (step S25). The fact that the farther the image display unit 20 from the mirror M, the smaller the image of the image display unit 20 in the captured image data can be used to calculate the distance. The image display unit 20 may instead be provided with a depth sensor or a distance meter facing in a direction that roughly coincides with the direction in which the camera 61 performs imaging. In this case, the image analysis section 182 may calculate the distance to the mirror M based on a detection value from the depth sensor or the distance meter. The depth sensor or the distance meter can, for example, be a device based on visible light, infrared light, laser light, or any other type of light or a device based on an ultrasonic wave.

The storage section 120 stores data representing the width (or diameter) of an average eye (pupil) of an adult, for example, as a setting value in the storage section 120. The image analysis section 182 calculates the distance between the user's pupils and the mirror M based on the width of one of the user's pupils extracted from the captured image data and the width represented by the data stored in the storage section 120. The distance between the user's pupils and the mirror M can be derived by performing computation using a computation expression set in advance for determination of an estimated value of the distance. The image analysis section 182 then determines the difference between the distance from the user's pupils to the mirror M and the distance calculated in step S25. The difference corresponds to the distance D1 in FIGS. 5A and 5B.

The storage section 120 may instead store data representing the width of each pupil measured on a user basis in place of the data representing an average eye of an adult. Still instead, the storage section 120 may store data on the size of an average face (vertical length and lateral width) in place of the width of each pupil, and the distance D1 can be determined based on the data on the size of an average face and data on the size of the user's face extracted from the captured image data.

The image analysis section 182 generates data on the position or the size of an image displayed by each of the right display driver 22 and the left display driver 24 based on the data calculated in the process described above (step S26). The adjustment control section 183 determines the display position and/or size based on the data produced by the image analysis section 182 (step S27), generates control data for adjustment of the display position and/or size, and outputs the control data to the image processing section 160 and/or the display control section 170 (step S28). The display position and display size of an image in each of the right LCD 241 and the left LCD 242 are thus adjusted. Further, the adjustment control section 183 may output image data for guiding purposes to the display control section 170 and notify the user that the display position and the display size of each of the images have been adjusted. In this case, the user may be allowed to input through the operation section 111 whether or not the user accepts the display position and the display size of each of the images after the adjustment or may be allowed to input instruction to terminate the adjustment or perform the adjustment again. The control section 140 then terminates the adjustment application program (step S29).

As described above, in the present embodiment, the adjustment control section 183 adjusts the size of an image based on the distance D1 between the pupils and the image display unit 20 and the distance between the image display unit 20 and the mirror M. In the configuration described above, the process of estimating (deriving) the distance D1 may be omitted. In this case, the adjustment control section 183 can adjust the display position and/or size of an image based only on the distance between the image display unit 20 and the mirror M. In this case, the size of the image can further be manually adjusted as required, for example, through operation performed by the user on the operation section 111. In addition to the omission of the estimation of the distance D1, the estimation of the distance between the image display unit 20 and the mirror M may be omitted. Even in a case where these estimations are omitted, the positions of images displayed by the right display driver 22 and the left display driver 24 relative to the positions of the right eye RE and the left eye LE can be appropriately adjusted.

As described above, the head mounted display 100 according to the embodiment to which the invention is applied includes a mounting section configured to be mounted on the user, the image display unit 20, which is provided in the mounting section and includes the right light guide plate 261 and the left light guide plate 262, which cause the image light L representing images to be incident on the user's eyes when the mounting section is mounted on the user, the camera 61, the image analysis section 182, which detects the matching state of the user's eyes relative to the right light guide plate 261 and the left light guide plate 262 based on an image captured with the camera 61 when the mounting section is mounted on the user, and the adjustment control section 183, which adjusts the image display unit 20 or the right light guide plate 261 and the left light guide plate 262 based on the matching state detected by the image analysis section 182.

The mounting section only needs to be a portion to be mounted on the user and can, for example, be the right holder 21 and the left holder 23, which come into direct contact with the user's body. Other components securely with which the right holder 21 and/or the left holder 23 are provided may be considered as part of the mounting section. Further, from the viewpoint of a mounted state, a component that does not come into contact with the user's body also corresponds to the mounting section. For example, the right light guide plate 261 and the left light guide plate 262 correspond to the mounting section because they are indirectly fixed to or held by the user's body. All components except a control system (receivers 53 and 54, right backlight control section 201, left backlight control section 202, right LCD control section 211, and left LCD control section 212) therefore independently or along with other components correspond to the mounting section. As a mounting section in a narrow sense, a structural object that comes into contact with the user's body or part of the structural object corresponds to the mounting section.

According to the configuration described above, when the head mounted display 100 is mounted on the user, the user can visually recognize an image in a preferable condition because the head mounted display 100 detects the matching state of the user's eyes relative to the right light guide plate 261 and the left light guide plate 262 and performs adjustment of the matching state.

The image analysis section 182 detects the positions of the right light guide plate 261 and the left light guide plate 262 relative to the position of the user's eyes based on an image captured with the camera 61 and the adjustment control section 183 adjusts the image display unit 20 or the right light guide plate 261 and the left light guide plate 262 based on the positions detected by the image analysis section 182, that is, the positions of the right light guide plate 261 and the left light guide plate 262 relative to the eyes in such a way that an image is positioned in correspondence with the eyes. As a result, the user can visually recognize the image in a preferable condition even when the head mounted display 100 is not mounted in an optimum position or at an optimum angle.

Further, the image display unit 20 includes the right display driver 22 and the left display driver 24, which output the image light L to the right light guide plate 261 and the left light guide plate 262. The right light guide plate 261 and the left light guide plate 262 have the half-silvered mirrors 261A and 262A, which reflect the image light L incident from the right display driver 22 and the left display driver 24 toward the user's eyes. The image analysis section 182 detects the matching state of the positions of the user's eyes relative to the positions of the half-silvered mirrors 261A and 262A. The position of the image light L incident on the user's eyes can therefore be adjusted in an appropriate position.

The camera 61 performs imaging in the direction of the user's line of sight when the mounting section is mounted on the user, and the image analysis section 182 detects the following images from an image captured with the camera 61: an image of the user reflected in a light reflector (mirror M, for example) located in a position in the direction of the user's line of sight; and an image of the image display unit 20 or the right light guide plate 261 and the left light guide plate 262 reflected in the light reflector, whereby the matching state of the user's eye relative to the right light guide plate 261 and the left light guide plate 262. For example, the camera 61 can be used to detect and recognize the object O located in a position in the directions of the user's line of sight and is further used when an AR image corresponding to the object O is displayed. Since the camera 61 that can be used for purposes other than the adjustment is used as described above, the apparatus configuration for the adjustment is not complicated.

Further, the image analysis section 182 detects an image of the user's eyes and an image of the right light guide plate 261 and the left light guide plate 262 from an image of the user reflected in the light reflector to detect the matching state of the user's eyes relative to the right light guide plate 261 and the left light guide plate 262, whereby the image reflected in the light reflector can be used to perform the adjustment more appropriately.

The invention is not limited to the configuration of the embodiment described above and can be implemented in a variety of aspects to the extent that they do not depart from the substance of the invention.

For example, the image display unit 20 may be replaced with an image display unit, for example, as a cap or any other image display unit to be mounted by a user. A display section that displays an image in correspondence with a user's left eye and a display section that displays an image in correspondence with the user's right eye only need to be provided. Moreover, the display apparatus according to the embodiment of the invention may, for example, be configured as a head mounted display incorporated in an automobile, an airplane, and other vehicles. Further, for example, the display apparatus may be configured as a head mounted display built in a helmet or other body protection gears. In this case, the mounting section can be a portion that positions the display apparatus with respect to the user's body and a portion that is positioned with respect to the positioning portion.

Further, in the embodiment described above, the description has been made of the case where the image display unit 20 and the control unit 10 are separate from each other and they are connected to each other via the connection section 40. The control unit 10 and the image display unit 20 can instead be integrated with each other, and the integrated unit can be mounted on a user's head.

The control unit 10 may instead be a notebook computer, a tablet computer, or a desktop computer. The control unit 10 may still instead be a mobile electronic apparatus including a game console, a mobile phone, a smartphone, and a mobile media player, or any other dedicated apparatus. Still instead, the control unit 10 may be separate from the image display unit 20, and the control unit 10 and the image display unit 20 may communicate with each other by transmitting and receiving a variety of signals based on wireless communication.

Further, for example, the configuration that generates image light in the image display unit 20 may be a configuration including an organic EL (organic electro-luminescence) display and an organic EL controller. Moreover, an LCOS (liquid crystal on silicon) device (LCoS is a registered trademark), a digital micromirror device, or any other device can be used as the image light generation configuration.

As the optical system that guides image light to a user's eyes, an employable configuration includes an optical member that transmits outside light incident from the outside on the display apparatus and allows the outside light along with the image light to be incident on the user's eyes. Another usable optical member may be disposed in a position in front of a user's eyes and may cover part or the entirety of the user's field of view. Still another employable optical system may be a scanning-type optical system that scans, for example, a laser beam to form image light. The optical system does not necessarily guide image light through an optical member and may only have a function of guiding image light toward the user's eyes based on refraction and/or reflection.

For example, the invention is also applicable to a laser-retina-projection-type head mounted display. That is, a configuration in which the light output section may include a laser light source and an optical system that guides a laser beam to a user's eyes may be employed. In this configuration, the laser beam may be caused to enter each of the eyes of the user's, and the laser beam may be scanned over the retina to form an image on the retina, so that the user is allowed to visually recognize an image.

The invention is also applicable to a display apparatus that employs a scanning optical system using a MEMS mirror and uses a MEMS display technology. That is, the light output section may include a signal light formation section, a sweep optical system having a MEMS mirror that scans light outputted from the signal light formation section, and an optical member on which the light scanned by the scanning optical system forms a virtual image. In this configuration, the light outputted from the signal light formation section is reflected off the MEMS mirror, is incident on the optical member, is guided through the optical member, and reaches a virtual image formation plane. The MEMS mirror scans the light to form a virtual image on the virtual image formation plane, and a user captures the virtual image with the eyes to recognize an image. The optical member in this case may be a multi-reflection light guide, such as the right light guide plate 261 and the left light guide plate 262 in the embodiment described above, or may be a half-silvered mirror.

Further, the optical elements in the embodiment of the invention are not limited to the right light guide plate 261 and the left light guide plate 262 having the half-silvered mirrors 261A and 262A and may instead be any optical parts that cause the image light to be incident on the user's eyes. Specifically, a diffraction grating, a prism, or a holographic display may be used.

At least part of the functional blocks shown in FIG. 3 may be achieved by hardware or hardware and software cooperating with each other, and the configuration in which independent hardware resources are arranged as shown in FIG. 3 is not necessarily employed. The program executed by the control section 140 may be stored in the storage section 120 or a storage device in the control unit 10. Instead, the control section 140 may acquire a program stored in an external apparatus via the communication section 117 or the interface 125 and execute the program. Among the components formed in the control unit 10, only the operation section 111 may be formed as an independent user interface (UI). Further, the components formed in the control unit 10 may be redundantly formed in the image display unit 20. For example, the control section 140 shown in FIG. 3 may be formed both in the control unit 10 and the image display unit 20, and the control section 140 formed in the control unit 10 and a CPU formed in the image display unit 20 may perform different functions.

What is claimed is:

1. A display apparatus comprising:
a mounting section configured to be mounted on a user;
a display section provided in the mounting section and including an optical element that causes image light representing an image to be incident on a user's eye when the mounting section is mounted on the user;
an imaging section provided in the mounting section;
a processing section that detects a matching state of the user's eye relative to the optical element based on an image captured with the imaging section when the mounting section is mounted on the user; and
an adjustment control section that adjusts the display section or the optical element based on the matching state detected by the processing section.

2. The display apparatus according to claim 1,
wherein the processing section detects the position of the optical element relative to the eye based on the image captured with the imaging section, and
the adjustment control section adjusts the display section or the optical element based on the relative position of the optical element relative to the eye detected by the processing section so that the position of the image matches with the eye.

3. The display apparatus according to claim 2,
wherein the display section includes a light output section that that outputs the image light to the optical element,
the optical element has a reflection surface that reflects the image light incident from the light output section toward the user's eye, and
the processing section detects the matching state of the positions of the user's eye relative to the position of the reflection surface.

4. The display apparatus according to claim 1,
wherein the imaging section performs imaging in the direction of the user's line of sight when the mounting section is mounted on the user, and
the processing section detects the user and the display section or the optical element reflected in a light reflector located in the direction of the user's line of sight from the image captured with the imaging section to detect the matching state of the user's eye relative to the optical element.

5. The display apparatus according to claim 4,
wherein the processing section detects the user's eye and the optical element reflected in the light reflector to detect the matching state of the positions of the user's eye relative to the position of the optical element.

6. A controlling method for a display apparatus, the display apparatus including:
a mounting section configured to be mounted on a user and provided with a display section and an imaging section, the display section including an optical element that causes image light representing an image to be incident on the user's eye when the mounting section is mounted on the user,
the controlling method comprising:
detecting a matching state of the user's eye relative to the optical element based on an image captured with the imaging section when the mounting section is mounted on the user and
adjusting the display section or the optical element based on the detected matching state.
